(19) United States
(12) Patent Application Publication
(10) Pub. No.: US 2021/0063673 A1
(43) Pub. Date: Mar. 4, 2021

(54) LENS MODULE

(71) Applicant: AAC Optics Solutions Pte. Ltd., Singapore City (SG)

(72) Inventor: Lingyun Xu, Shenzhen (CN)

(21) Appl. No.: 16/927,983

(22) Filed: Jul. 13, 2020

(30) Foreign Application Priority Data
Sep. 4, 2019 (CN) 201921465077.0

(51) Int. Cl. G02B 7/02

(52) U.S. Cl. CPC G02B 7/021; G02B 13/18; G02B 7/025

(57) ABSTRACT

The present disclosure provides a lens module, which includes a lens barrel defining an accommodating space and a lens group accommodated in the lens barrel. The lens barrel includes an inner surface enclosing the accommodating space and an outer surface disposed opposite to the inner surface. The lens group includes a first lens adjacent to an object side and a second lens adjacent to an image side. The lens module further includes a spacer ring disposed between the first lens and the second lens. The spacer ring includes a first surface adjacent to the object side, a second surface disposed opposite to the first surface and adjacent to the image side, and a glue penetration hole recessing from one of the first surface and the second surface to the other. A cured glue layer is formed in the glue penetration hole to support the spacer ring.

### TECHNICAL FIELD

The present disclosure relates to the field of optical imaging technology, in particular to a lens module.

### BACKGROUND

In recent years, with the continuous development of science and technology, electronic devices are continuously developing towards intelligence. In addition to digital cameras, portable electronic devices such as tablet computers and mobile phones are also equipped with lens modules having photo shooting and video shooting functions, as well as vehicles such as cars are equipped with the lens modules having the photo shooting and video shooting functions, so as to meet the needs of users to take photos at any time.

The lens module in the related technology includes a lens barrel and a lens group accommodated in the lens barrel. The lens group includes a plurality of lenses, and a stepped structure is usually adopted inside the lens barrel for supporting the lens group and preventing the internal components from deforming. The lens groups of the lens modules in the related technology are stacked. In a case of a large difference between outer diameters of two adjacent lenses, the bearing positions of the lens with a larger outer diameter and the lens with a smaller outer diameter forms an unstable structure, the spacer ring may be seriously deformed when the pressure applied thereto is increased, and thus the lens performance is affected. Meanwhile, it is difficult to effectively alleviate the deformation of the spacer ring as the edge thickness tolerance of the lens and the processing deviation of the stepped structure may affect the supporting effect of the stepped structure.

Therefore, it is necessary to provide a new lens module to solve the above problems.

### SUMMARY

At present, in the related technology, the lens with a large outer diameter may be seriously deformed when the pressure applied thereto is increased, and it is difficult to effectively alleviate the deformation of internal components as the edge thickness tolerance of the lens and the processing deviation of the stepped structure may affect the supporting effect of the stepped structure. Therefore, the present disclosure provides a new lens module.

A lens module includes a lens barrel defining an accommodating space and a lens group accommodated in the lens barrel. The lens barrel includes an inner surface enclosing the accommodating space and an outer surface disposed opposite to the inner surface. The lens group includes a first lens adjacent to an object side of the lens barrel and a second lens adjacent to an image side of the lens barrel, and the first lens and the second lens are sequentially stacked. The lens module further includes a spacer ring disposed between the first lens and the second lens. The spacer ring includes a first surface adjacent to the object side, a second surface disposed opposite to the first surface and adjacent to the image side, and a glue penetration hole recessing from one of the first surface and the second surface to the other. After dispensing and curing of glue, a cured glue layer is formed in the glue penetration hole to support the spacer ring.

As an improvement, the glue penetration hole penetrates through the first surface and the second surface.

As an improvement, the first surface partially abuts against the first lens and the other part of the first surface abuts against the inner surface of the lens barrel.

As an improvement, the first surface has a part abutting against the first lens and the other part spaced from the inner surface of the lens barrel to form a gap, and the cured glue layer extends to the gap.

As an improvement, each of the first lens and the second lens includes an optical portion for imaging and a bearing portion disposed around the optical portion, and the spacer ring at least partially abuts against the bearing portion.

As an improvement, an outer diameter of the second lens is larger than an outer diameter of the first lens.

As an improvement, multiple glue penetration holes are provided and disposed at equal intervals around an optical axis of the lens group.

As an improvement, the glue penetration hole is circular on a section perpendicular to the optical axis.

As an improvement, the glue penetration hole is fan-shaped on a section perpendicular to the optical axis.

As an improvement, the glue penetration hole is parallel to an optical axis of the lens group on a section where the optical axis is located.

The lens module provided in the present invention is provided with the spacer ring between the first lens and the second lens, and the spacer ring is provided with the glue penetration hole penetrating through the first surface and the second surface. The glue penetration hole recesses from one of the first surface and the second surface to the other. After dispensing and curing of the glue, the cured glue layer is formed in the glue penetration hole to support the spacer ring. The above structure has a good supporting effect on the lens group without affecting the installation of the lens group, which can alleviate the deformation of the spacer ring, improve a production yield and improve the reliability of the lens module.

### BRIEF DESCRIPTION OF THE DRAWINGS

In order to illustrate the technical solution in the embodiments of the present disclosure more clearly, the accompanying drawings used in the description of the embodiments are briefly introduced below. It is apparent that the drawings descripted below are merely some embodiments of the present disclosure. For those skilled in the art, other drawings may be obtained in accordance with these drawings without any creative work, where:

FIG. 1 is a schematic diagram showing a sectional view of a lens module according to Embodiment 1 provided in the present disclosure;

FIG. 2 is an exploded view of the lens module shown in FIG. 1;

FIG. 3 is a schematic diagram showing a sectional view of the lens module according to Embodiment 2 provided in the present disclosure;

FIG. 4 is an exploded view of parts of the lens module shown in FIG. 3;

FIG. 5 is a schematic diagram showing a sectional view of the lens module according to Embodiment 3 provided in the present disclosure;

FIG. 6 is a schematic diagram showing a sectional view of the lens module according to Embodiment 4 provided in the present disclosure.

### DETAILED DESCRIPTION

The technical solutions in the embodiments of the present disclosure will be clearly described in details with reference to the accompanying drawings in the present disclosure. It is evident that the embodiments described are merely some rather than all embodiments in the present disclosure. Based on the embodiments of the present disclosure, all other embodiments obtained by those of ordinary skills in the art without any creative work shall fall within the protection scope of the present disclosure.

### Embodiment 1

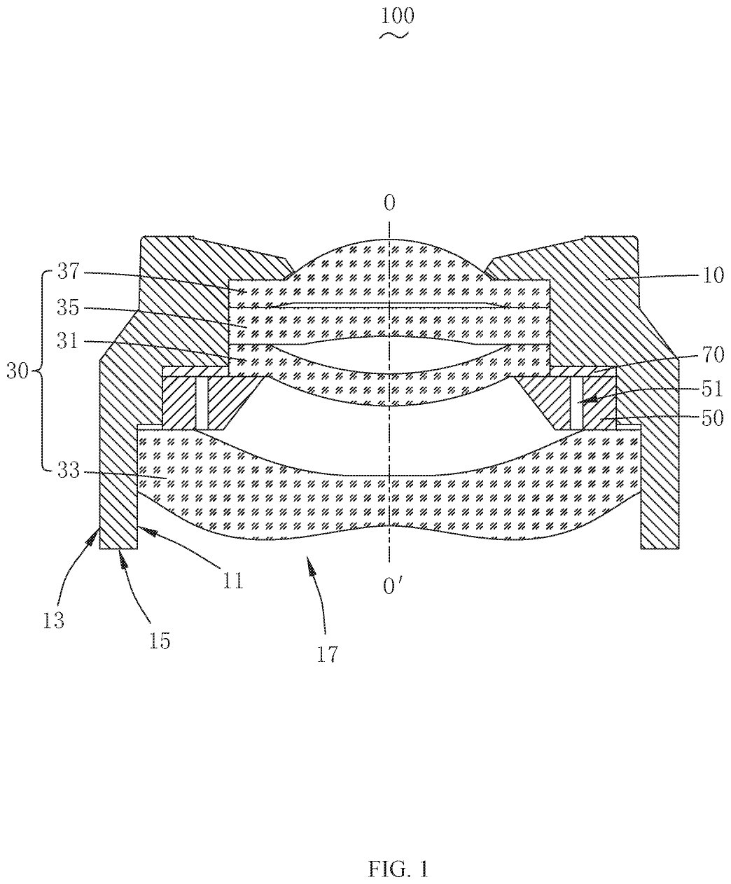

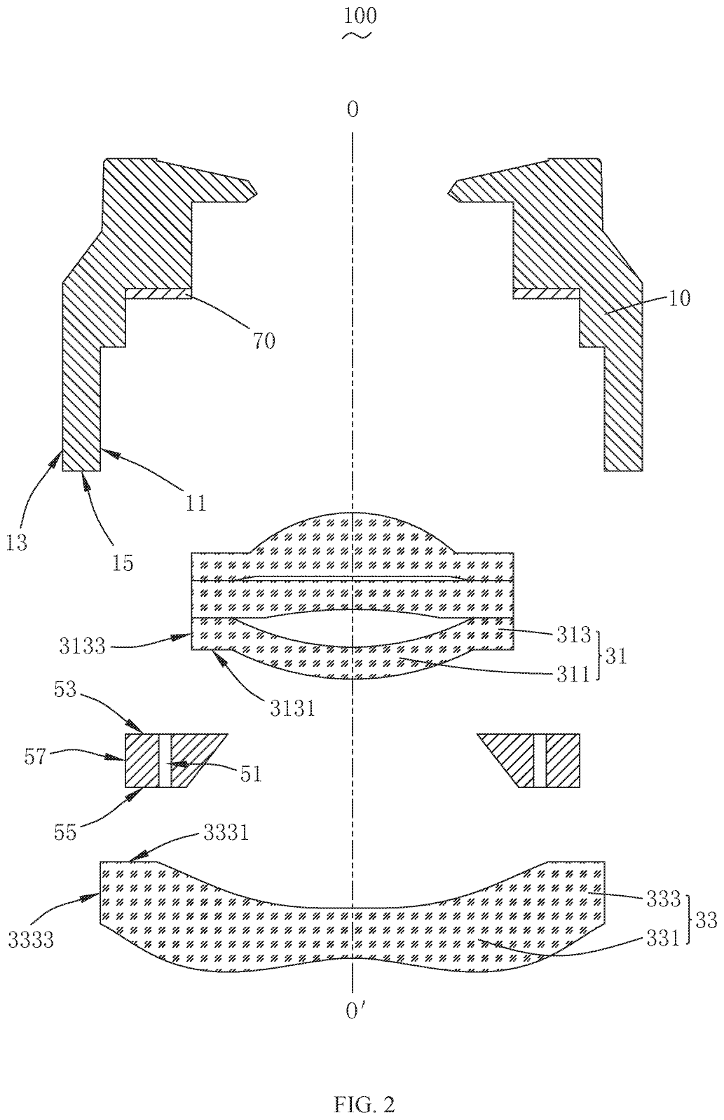

Referring to FIG. 1 to FIG. 2, FIG. 1 is a schematic diagram showing a sectional view of a lens module according to the Embodiment 1 provided in the present disclosure. The lens module 100 includes a lens barrel 10 defining an accommodating space 17, a lens group 30 formed by a plurality of lenses whose optical axes are coaxial with each other and which are arranged sequentially from an object side to an image side and closely in the accommodating space 17, and at least one spacer ring 50 disposed in the accommodating space 17. The object side refers to a side of the lens barrel 10 adjacent to an object when in use, and the image side refers to a side opposite to the object side.

The lens barrel 10 includes an inner surface 11 adjacent to the optical axis, an outer surface 13 disposed opposite to the inner surface 11, and a bottom surface 15 facing the image side and connecting the inner surface 11 and the outer surface 13. The inner surface 11 encloses the accommodation space 17 for accommodating the lens group 30. Preferably, the inner surface 11 has a stepped structure matched with the lens group 30, and a periphery of the lens of the lens group 30 abuts against the stepped structure of the inner surface 11 to realize a fixation of the lens.

The lens group 30 includes the plurality of lenses whose optical axes are coaxial with each other and which are arranged sequentially from an object side to an image side and closely in the accommodating space 17. Specifically, in this embodiment, the lens group 30 includes a first lens 31 accommodated in the lens barrel 10, a second lens 33 on at an image side of the first lens 31, a third lens 35 at an object side of the first lens 31 and a fourth lens 37 at an object side of the third lens 35. The arrangement of the plurality of lenses enables the lens module 100 to display more details during imaging. The first lens 31 includes an optical portion 311 for imaging and a bearing portion 313 disposed around the optical portion 311. The bearing portion 313 includes an image-side surface 3131 adjacent to the image side and a first connecting surface 3133 fixedly connected to the inner surface 11 of the lens barrel 10. The first connecting surface 3133 and the inner surface 11 are fixed by dispensing of glue. The second lens 33 includes an optical portion 331 for imaging and a bearing portion 333 disposed around the optical portion 331. The bearing portion 333 of the second lens 33 includes an object-side surface 3331 adjacent to the object side and a second connecting surface 3333 fixedly connected to the inner surface 11 of the lens barrel 10. The second connecting surface 3333 and the inner surface 11 are fixed by dispensing. In particular, an outer diameter of the second lens 33 is larger than that of the first lens 31.

Those skilled in the art may understand that the lens group 30 shown in FIG. 1 is merely exemplary. The number of the lenses included in the actual lens group varies greatly according to different types of the lens barrels and different focal lengths.

The spacer ring 50 is located between the first lens 31 and the second lens 33. The spacer ring 50 includes a first surface 53 adjacent to the object side, a second surface 55 adjacent to the image side, a third connecting surface 57 connecting the first surface 53 and the second surface 55, and a glue penetration hole 51 recessing from one of the first surface 53 and the second surface 55 to the other. The third connecting surface 57 abuts against the inner surface 11 of the lens barrel 10. After dispensing and curing of the glue, a cured glue layer is formed in the glue penetration hole 51 to support the spacer ring 50.

Specifically, the glue penetration hole 51 penetrates through the first surface 53 and the second surface 55. The first surface 53 has a part abutting against the image-side surface 3131 of the first lens 31, and the other part spaced from the inner surface 11 of the lens barrel 10 to form a gap. The glue enters the gap through the glue penetration hole 51 and forms the cured glue layer 70 for supporting the spacer ring after curing. The second surface 55 abuts against the object-side surface 3331 of the second lens 33.

In particular, multiple glue penetration holes 51 may be provided and disposed in various ways. In this embodiment, the multiple glue penetration holes 51 are disposed at equal intervals around the optical axis. On a section where the optical axis is located, the glue penetration hole 51 is parallel to the optical axis. In addition, on a section perpendicular to the optical axis, the shape of the glue penetration hole 51 may be circular, fan-shaped, square, and rectangular or other shapes. In this embodiment, the glue penetration hole 51 is circular in the section perpendicular to the optical axis.

Further, the cured glue layer 70 is formed in an accommodating space defined by the first surface 53, the first connecting surface 3133 of the first lens 31 and the inner surface 11 of the lens barrel 10. The cured glue layer 70 is formed by curing of the glue after entering from the glue penetration hole 51, which has a good supporting effect and may not affect the installation of the lens group 30. The spacer ring 50 and the cured glue layer 70 are both disposed at the stepped structure of the lens barrel 10, resulting in a good supporting effect.

The lens module 100 provided in the present invention is provided with the spacer ring 50 between the first lens 31 and the second lens 33, and the spacer ring 50 is provided with the glue penetration hole 51 penetrating through the first surface 53 and the second surface 55. The glue penetration hole 51 recesses from one of the first surface 53 and the second surface 55 to the other. After dispensing and curing of the glue, the cured glue layer is formed in the glue penetration hole 51 to support the spacer ring 50. The above structure has the good supporting effect on the lens group 30 without affecting the installation of the lens group 30, which can alleviate the deformation of the spacer ring, improve a production yield and improve the reliability of the lens module.

### Embodiment 2

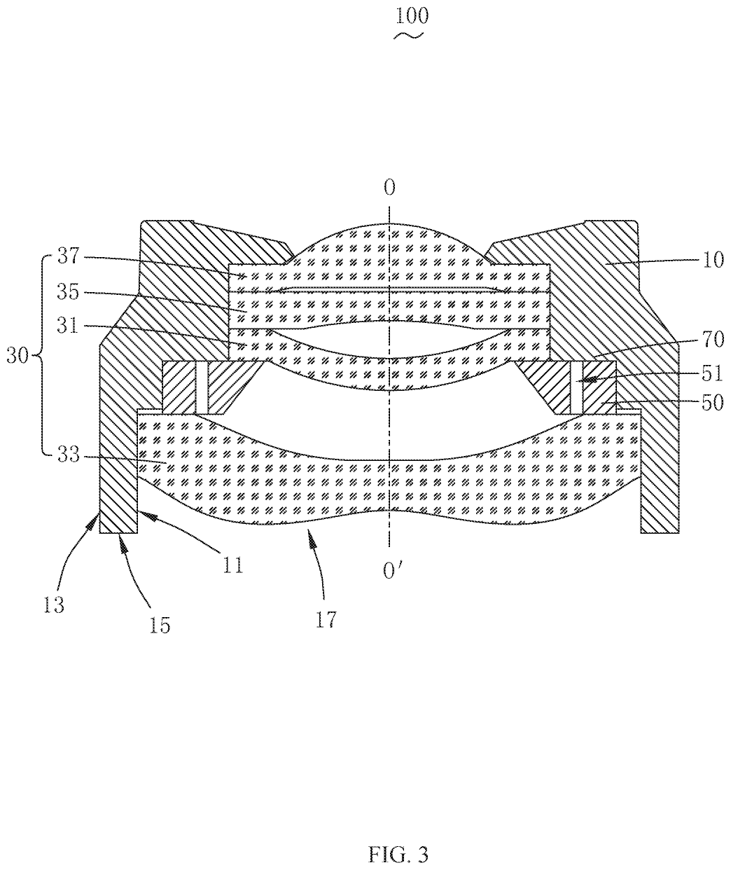

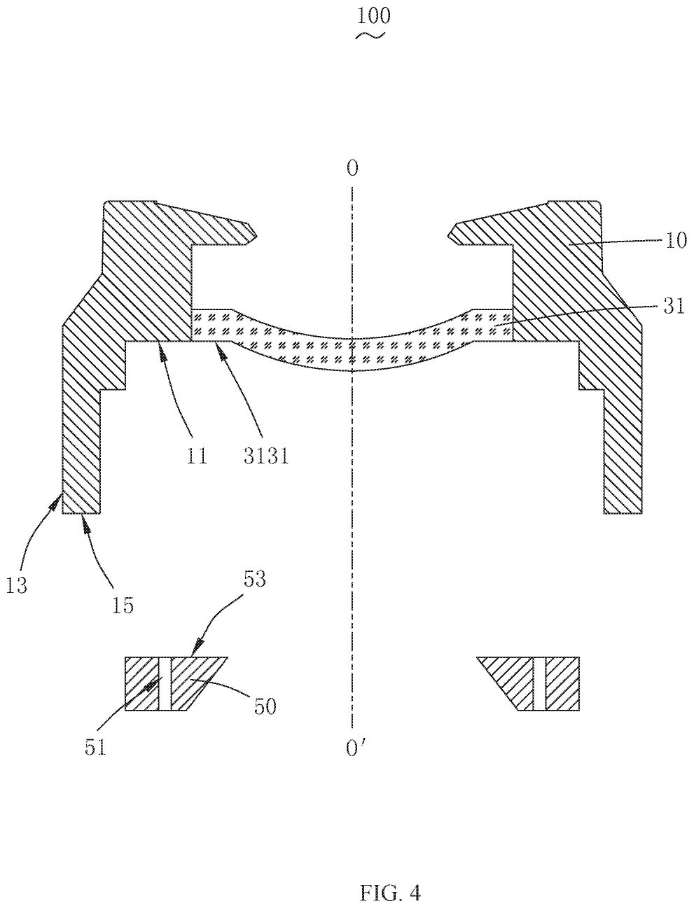

Referring to FIG. 3 to FIG. 4, FIG. 3 is a schematic diagram showing a sectional view of the lens module according to the Embodiment 2 provided in the present disclosure. The Embodiment 2 is basically the same as the Embodiment 1, with the same definition symbols. Only the differences are listed below. Specifically, the glue penetration hole 51 penetrates through the first surface 53 and the second surface 55. Different from the Embodiment 1, the first surface 53 has a part abutting against the image-side surface 3131 of the first lens 31, and the other part abutting against the inner surface 11 of the lens barrel 10. There is no gap between the spacer ring 50 and the lens barrel 10.

### Embodiment 3

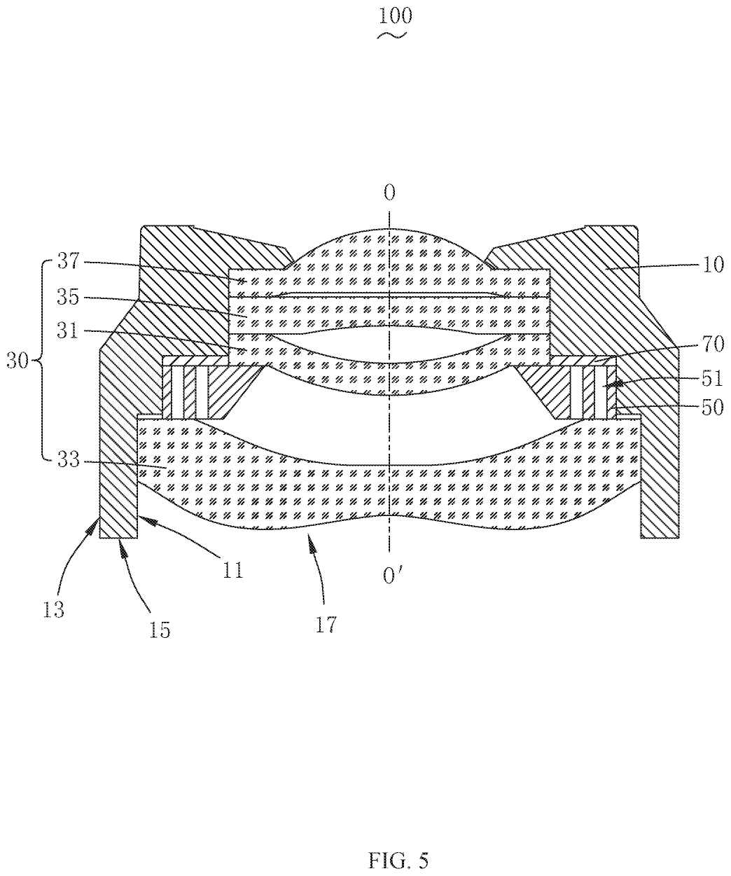

Referring to FIG. 5, FIG. 5 is a schematic diagram showing a sectional view of the lens module according to Embodiment 3 provided in the present disclosure. The Embodiment 3 is basically the same as the Embodiment 1, with the same definition symbols. Only the differences are listed below. The glue penetration holes 51 are arranged in two layers, which are an inner layer and an outer layer. The glue penetration holes 51 arranged in the two layers may be disposed at equal intervals around the optical axis or arranged in a fold line. Specifically, in this embodiment, the glue penetration holes 51 arranged in the two layers are disposed at equal intervals around the optical axis.

### Embodiment 4

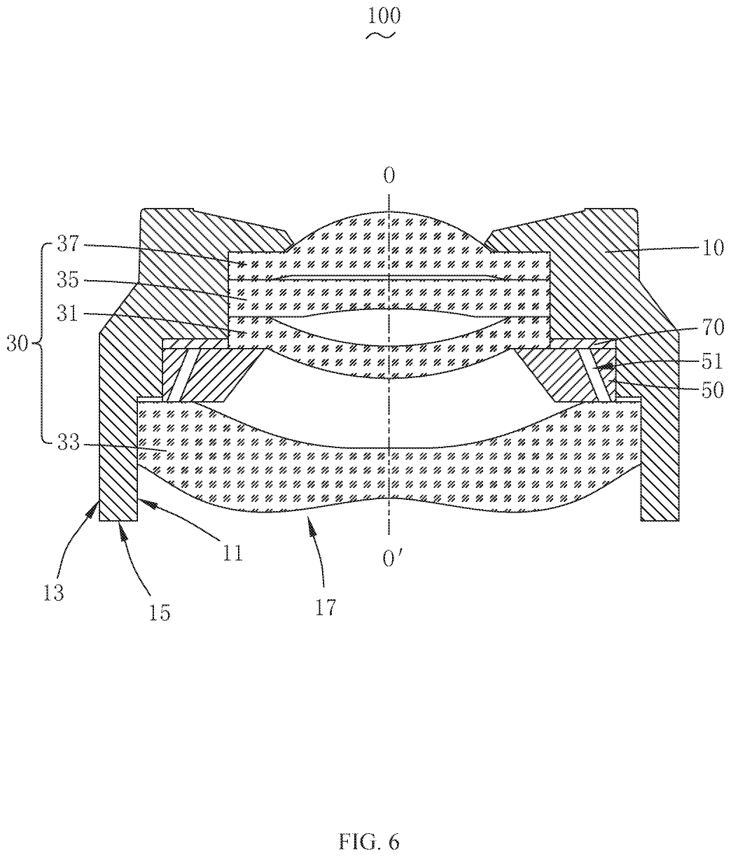

Referring to FIG. 6, FIG. 6 is a schematic diagram showing a sectional view of the lens module according to the Embodiment 4 provided in the present disclosure. The Embodiment 4 is basically the same as the Embodiment 1, with the same definition symbols. Only the differences are listed below. On a section where the optical axis is located, the glue penetration hole 51 does not have to be parallel to the optical axis. In this embodiment, the glue penetration hole 51 is disposed at a certain angle with the optical axis.

The above description is merely embodiments of the present disclosure. It should be appreciated that, those of ordinary skills in the art may make improvements without departing from the inventive concept of the present disclosure, such improvements, however, fall within the protection scope of the present disclosure.

What is claimed is:

1. A lens module, comprising a lens barrel defining an accommodating space and a lens group accommodated in the lens barrel, the lens barrel comprising an inner surface enclosing the accommodating space and an outer surface disposed opposite to the inner surface, the lens group comprising a first lens adjacent to an object side of the lens barrel and a second lens adjacent to an image side of the lens barrel, and the first lens and the second lens being sequentially stacked, wherein the lens module further comprises a spacer ring disposed between the first lens and the second lens, the spacer ring comprises a first surface adjacent to the object side, a second surface disposed opposite to the first surface and adjacent to the image side, and a glue penetration hole recessing from one of the first surface and the second surface to the other, and after dispensing and curing of glue, a cured glue layer is formed in the glue penetration hole to support the spacer ring.

2. The lens module according to claim 1, wherein the glue penetration hole penetrates through the first surface and the second surface.

3. The lens module according to claim 1, wherein the first surface has a part abutting against the first lens and the other part abutting against the inner surface of the lens barrel.

4. The lens module according to claim 2, wherein the first surface has a part abutting against the first lens and the other part spaced from the inner surface of the lens barrel to form a gap, and the cured glue layer extends to the gap.

5. The lens module according to claim 1, wherein each of the first lens and the second lens comprises an optical portion for imaging and a bearing portion disposed around the optical portion, and the spacer ring at least partially abuts against the bearing portion.

6. The lens module according to claim 1, wherein an outer diameter of the second lens is larger than an outer diameter of the first lens.

7. The lens module according to claim 1, wherein multiple glue penetration holes are provided and disposed at equal intervals around an optical axis of the lens group.

8. The lens module according to claim 7, wherein the glue penetration hole is circular on a section perpendicular to the optical axis.

9. The lens module according to claim 7, wherein the glue penetration hole is fan-shaped on a section perpendicular to the optical axis.

10. The lens module according to claim 1, wherein the glue penetration hole is parallel to an optical axis of the lens group on a section where the optical axis is located.
